(19) United States
(12) Patent Application Publication
(10) Pub. No.: US 2002/0116258 A1
(43) Pub. Date: Aug. 22, 2002

(54) Method for selecting and directing internet communications

(76) Inventors: George Stamatelatos, Seattle, WA (US); Diane McCowin, Seattle, WA (US); Judy Loschen, Bellevue, WA (US)

Correspondence Address: Bennet K. Langlotz PC, 2850 SW Fairmount Blvd., Portland, OR, 97201, US

(21) Appl. No.: 09/731,442

(22) Filed: Dec. 6, 2000

(51) Int. Cl. G06F 17/60

(52) U.S. Cl. 705/14

(57) ABSTRACT

A method of commercial communication includes generating a reference data set based on a set of responses by a set of reference users to a number of alternative Internet communications such as different advertisements. A number of user activity categories are established, each corresponding to a different level of user activity. The data set is analyzed to establish a number of value indicators based on a propensity of the reference user to move to an activity category having a higher level of activity. For each permutation of activity category and value indicator, an Internet communication is selected from the selected set.

### FIELD OF THE INVENTION

This invention relates to internet commerce, and more particularly to selection of advertising communications based on user characteristics.

### BACKGROUND AND SUMMARY OF THE INVENTION

Internet-based advertising uses many different channels and techniques to reach consumers. Examples include but are not limited to banner advertisements and emails, each of which may take many different forms, with degrees of customization and personalization, in addition to different content. The selection of which message form and content is optimal depends partially on the cost to deliver such a message, and more significantly on the expected effectiveness of the advertisement based on what is know about the recipient. Overall, it is desired to optimize the ratio of effectiveness to cost for any advertising effort.

Existing advertising strategies may base the selection of advertising strategy (form and content of a message) on the current or past contacts by a user. For instance, a user visiting an advertiser's web site is identified each time by the advertiser receiving a unique device identifier associated with the user's computer or other device used to visit the site. The advertiser maintains a database of all users and the number and nature of visits for each user. When the user visits the advertiser site again, or is detected visiting another site at which the advertiser has arranged for placement of a banner advertisement, the user is detected, associated records are located, an advertisement is selected based on the current or past activity, and the optimal advertisement is displayed to the user.

While effective, the technique of selecting advertising strategy based on current or past activity levels has certain limitations. Of greatest concern is the determination, using current or past information, of the optimal advertising. This includes understanding the customer relationship to the advertiser, the predicted outcome of the advertisement, and the best communication channel.

The present invention overcomes the limitations of the prior art by providing a method of commercial communication that includes generating a reference data set based on a set of responses by a set of reference users to a number of alternative Internet communications such as different advertisements. A number of user activity categories are established, each corresponding to a different level of user activity based on the users relationship to the advertiser. The data set is analyzed to establish a number of value indicators based on a propensity of the reference user to move to an activity category having a higher level of activity. For each permutation of activity category and value indicator, an Internet communication is selected from the selected set.

### BRIEF DESCRIPTION OF THE DRAWINGS

FIG. 1 is a schematic block diagram showing the system and method of operation according to a preferred embodiment of the invention.

FIG. 2 is a graphical representation of an exemplary Internet advertising function according to the preferred embodiment of the invention.

### DETAILED DESCRIPTION OF A PREFERRED EMBODIMENT

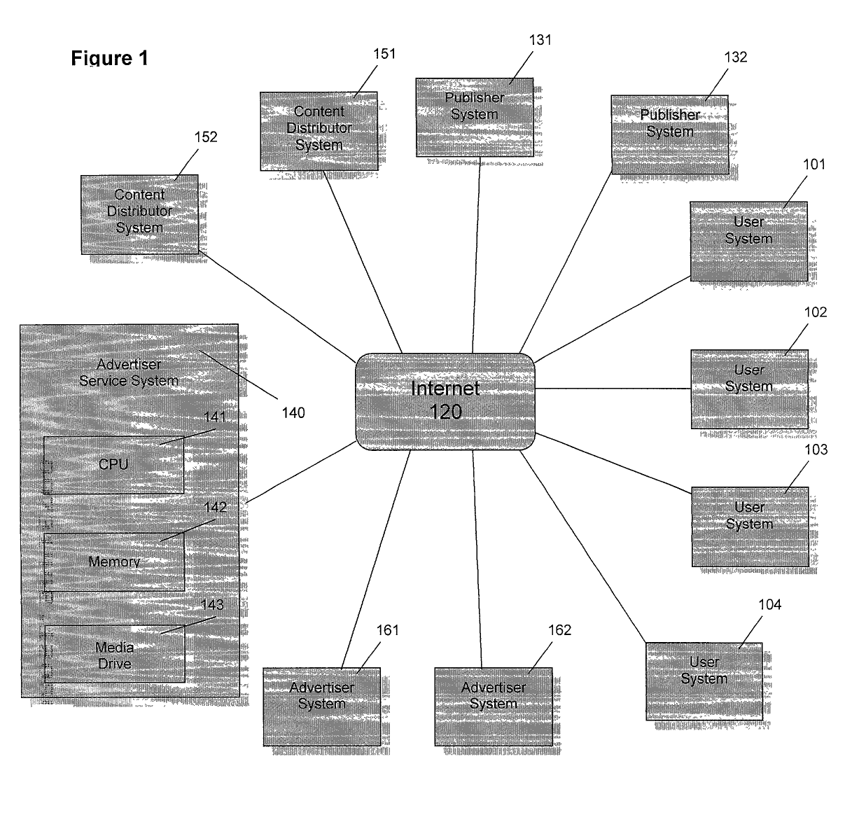

FIG. 1 is a high-level block diagram showing the environment in which the facility preferably operates. The diagram shows a number of Internet customer or user computer systems 101-104. An Internet customer preferably uses one such Internet customer computer system to connect, via the Internet 120, to an Internet publisher computer system, such as Internet publisher computer systems 131 and 132, to retrieve and display a Web page. Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities.

In cases where an Internet advertiser, through the Internet advertising service company, has purchased advertising space on the Web page provided to the Internet customer computer system by the Internet publisher computer system, the Web page contains a reference to a URL in the domain of the Internet advertising service company computer system 140. When a customer computer system receives a Web page that contains such a reference, the Internet customer computer systems sends a request to the Internet advertising service computer system to return data comprising an advertising message, such as a banner advertising message. When the Internet advertising service computer system receives such a request, it selects an advertising message to transmit to the Internet customer computer system in response the request, and either itself transmits the selected advertising message or redirects the request containing an identification of the selected advertising message to an Internet content distributor computer system, such as Internet content distributor computer systems 151 and 152. When the Internet customer computer system receives the selected advertising message, the Internet customer computer system displays it within the Web page. The Internet advertising service is not limited to banner advertisement, which are used as an example. Other Internet advertising modes include email messages directed to a user who has provided his or her email address in a request for such messages.

The displayed advertising message preferably includes one or more links to Web pages of the Internet advertiser's Web site. When the Internet customer selects one of these links in the advertising message, the Internet customer computer system de-references the link to retrieve the Web page from the appropriate Internet advertiser computer system, such as Internet advertiser computer system 161 or 162. In visiting the Internet advertiser's Web site, the Internet customer may traverse several pages, and may take such actions as purchasing an item or bidding in an auction. The Internet advertising service computer system 140 preferably includes one or more central processing units (CPUs) 141 for executing computer programs such as the facility, a computer memory 142 for storing programs and data, and a computer-readable media drive 143, such as a CD-ROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

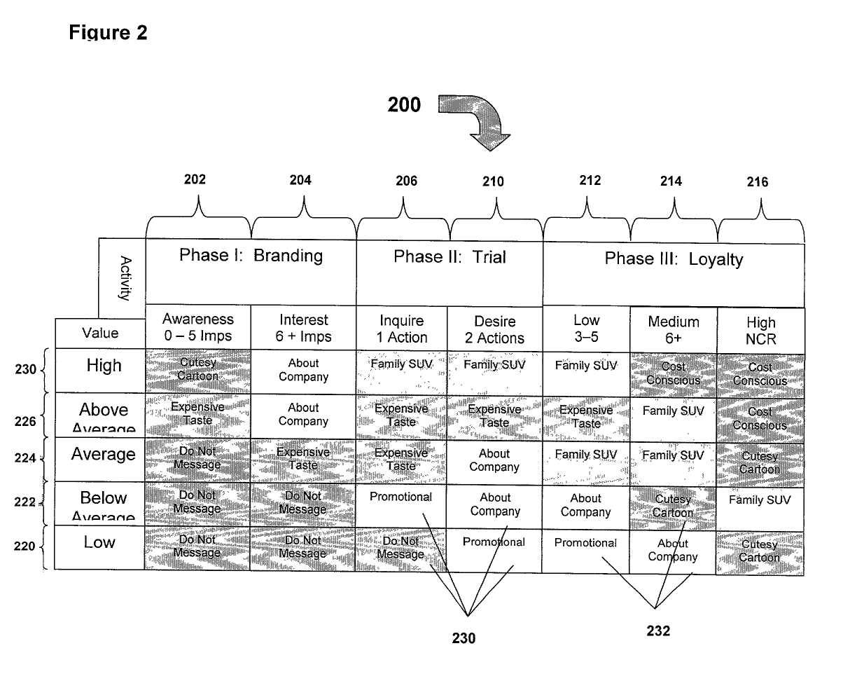

FIG. 2 shows a table 200 illustrating one example of how advertising are selected. The table has a horizontal axis having several categories 202, 204, 206, 210, 212, 214, 216 corresponding to current or past customer activity levels. The table has a vertical axis having several categories corresponding to range of customer “value” levels 220, 222, 224, 226, 230, from low to high, corresponding to a predicted probability that a customer will advance to a higher activity level (i.e. rightward to a higher activity column in the graph). The graph has a matrix of cells 230, each corresponding to a given activity level and a given value. Each cell of the matrix is labeled with a selected advertising or marketing plan identifier 232, which may include the mode of communication, and the content of the communication to be delivered to users who fall into the associated cell.

In the illustrated example, the activity levels are:

Awareness, with zero to five impressions by the advertising business on a user or potential customer, an impression typically being an advertisement served to the user;

Interest, six or more impressions;

Inquire, with one action such as visiting a home page, or other positive activity by the user;

Desire, two actions;

Low level loyalty, three to five actions;

Medium loyalty, six or more actions; and

High loyalty, reflecting a special activity such as a major purchase, or in this example, a referral of another customer.

The activity levels are grouped into Phase I: Branding, which includes categories 202 and 204, Phase II Trial, including categories 206 and 210, and Phase III: Loyalty, which includes the three loyalty levels. The value levels are established by a scoring system as discussed below.

The advertising identifiers 232 refer to various specific advertisements, techniques, campaigns, and methods. The identifier may indicate “no action,” in which the user is not served an advertisement of any type in any form. The advertisement may be: a banner ad, email or any other advertising channel with any of a range of forms and contents such as;

simple brand awareness content—specific content related to products or services available, possibly selected and customized for the user;

promotional discounts—possibly of a selectable amount targeted to the user;

reward message—possibly selected and customized for the user;

cross sell message—possibly selected and customized for the user;

up-sell message—possibly selected and customized for the user;

retention message—possibly selected and customized for the user.

Where an email is associated in a database of the advertising service company with the cookie or other unique device identifier of the device with which the user is contacting the Internet, the advertising technique may include generating an email message to the user. Alternative techniques include other direct messages to the user, such as voice mail messages, pager messages, mailings, and telephone contact, based on contact information provided by the user, and on the suitability and effectiveness of such a method as predicted by calculations discussed below.

The advertising technique may also select from among messages relating to different clients/advertisers of the advertising service company. For instance, a user may visit a site at which the advertising service company has arranged to serve advertisements. After identifying the user by the associated cookie, it may be determined that a particular client's/advertiser's advertisement would be most effective for that particular customer.

The advertising identifiers 232 include several specific examples. “Cutesy Cartoon” suggests a banner advertisement designed to attract interest and develop brand awareness. “About Company” includes more detailed information telling a user about the advertising company's products or services. “Family SUV” is an advertisement related to a specific category of products of likely interest to a given user, based on prior web surfing data previously collected. “Expensive Taste” is an advertisement selected for a particular predicted economic characteristic, as is “Cost Conscious.” “Promotional” indicates an advertisement including a promotional discount, used to motivate higher activity. A multitude of alternative advertisement strategies may be included, with each cell having its own different advertisement or group of advertisements for each channel.

The matrix is not only a graphical representation of a function of action and value factors. In fact, it is a graphical tool for communicating complex quantitative and strategic information. Communication between an advertising service company and an advertiser can be facilitated by using the matrix to visually convey the strategic advertising plan, so that patterns and groups of different categories of users in different cells can be displayed for discussion and revision. The matrix also allows the testing of multiple strategies within each given cell. This experimentation allows the advertiser to always use the optimal solution based on intuitive or quantitative driven strategies. These strategies can be test against a control or a do not advertise group in order to derive the true lift of that advertisement.

The activity level of a user is determined based on past advertiser experience and the resulting success of the advertisement defined as rightward movement to a higher level of activity. Patterns of past user activities are collected and analyzed. The limits of each category of activity level are preferably established so that there are meaningful differences between categories. Bivariate analysis of the past activity compared to the expected, or future, activity level (conversion rate) is completed. This analysis allows for establishment of the category divisions where the bivariate analysis shows inflection points in customer response to advertising. This graph of the actions for users based on number of ads served will generally increase, because actions taken by a user is more likely as more advertisements are served. However, the curve is generally not straight or smooth. Therefore, category divisions are established where the curve has discontinuities or steep increases. In the illustrated example, the category limits between the first and second activity levels are based on a finding that the actions taken is relatively flat from three to five impressions, but jumps somewhat for a sixth impression, and continues relatively flat, as additional impressions beyond six do not appreciably increase the likelihood of user action. A similar effort is made to establish the limits for the higher activity level categories, based on demonstrated distinctions in actions based on prior activity levels.

A distinct calculation of the value score is completed for each activity level. The value level must be calculated based on a set of variables or characteristics known about the specific user such as information from the web browsing or other web traffic data including client specific data. These factors, upon which a value calculation may be specific to the advertiser client, or may be general factors simply relating to the user's activity. A wide range of possibly significant factors having a potential predictive value may be hypothesized, and then are tested by a bivariate analysis to discern which factors are significant, and to what degree, this result is a function that establishes the value level for each user for these specific variables.

To establish the functions predictive of user value, data must first be gathered during an initial period or the observation time period. Typically, a body of data is collected about users who are served advertisements. The data collection phase collects data about each user's activity and characteristics; such as when shown an advertisement by the advertising company, or interaction with the advertising company's client website. This past data is retrieved from a data base in the advertising service company's storage device.

The data may include other advertisements of other advertisers served to the user by the advertising service company, and/or may include information specific to an advertiser for whom an advertising campaign or custom matrix is being developed. For each user from whom data is gathered, a record is established that includes historic web browsing and other activity prior to being served the test advertisement, plus the most recent activity in response to viewing the advertisement served, for a period following the advertisement or the outcome time period, to discern the degree of any effects of the advertisement.

Multiple transaction-level (view an ad, clicked on an ad, etc.) records exist for each user. As a next step, this data is transformed into user level variables that describe behavior over many transactions. For example, the date of the first transaction or the total number of transactions is calculated.

The next step in establishing value levels is a bivariate analysis of each variable hypothesized as a possible predictor of propensity to shift to a higher level of activity. For each variable, the activity advancement of each user in the sample is compared against the descriptive variable. For variables that are a matter of degree or quantity, such as total number of Internet actions, the numbers may grouped into logical categories based on how the data logically groups clusters. Boolean variables are simply grouped into two categories. Others are grouped logically, such as seven categories for day of the week.

Variables not exhibiting any effect on propensity for future action are discarded or given a value of zero, and the remaining variables are assigned scores using multivariate linear regression to weight the degree of their effect. An example charting several significant variables is illustrated below:

| Variable | Step | Value |
|---|---|---|
| Constant | N/A | 298 |
| Number of Internet actions | 0-1 | 0 |
| | 2-3 | 77 |
| | 4-7 | 96 |
| | 8-10 | 124 |
| | 11-19 | 138 |
| | 20-45 | 189 |
| | 46-91 | 216 |
| | 92 or more | 276 |
| Number of clicks at | 0 | 0 |
| advertiser/client web site | 1 or more | 226 |
| Number of advertiser ad | 0-6 | 0 |
| impressions | 7-10 | 12 |
| | 11 or more | 0 |
| Number of clicks to | 0 | 0 |
| Advertising service company | 1-2 | 34 |
| | 3 or more | 43 |
| Number of Internet downloads | 0 | 0 |
| | 1 or more | 57 |
| Most common day of week for | Sunday | 25 |
| Internet usage | Monday | 51 |
| | Tuesday | 0 |
| | Wednesday | 0 |
| | Thursday | 0 |
| | Friday | 25 |
| | Saturday | 0 |
| | Unknown | 0 |
| Web surfing genre category | Finance | 80 |
| | Lifestyle | 0 |
| | News | 0 |
| | Shopping | 23 |
| | Sports | 17 |
| | Technology | 0 |
| | Travel | 96 |
| | Unknown | 0 |
| Number of homepage actions | 0 | 0 |
| | 1 | 46 |
| | 2-4 | 51 |
| | 5 or more | 54 |
| bNumber of promotional actions | 0 | 0 |
| | 1 or more | 68 |
| Most common time of Internet | Night owl | −37 |
| usage | Morning | 0 |
| | Daytime | 0 |
| | Nighttime | 0 |
| | Unknown | 0 |

A function is based on the values associated with each of these variables. To apply the function to a selected user (and thereby determine into which cell the user falls and thereby to determine which advertisement to serve), a total score is generated by adding the value for each variable associated with the user. The sum of the values is the total value. Each of the value categories corresponds to a range of values, so that the score for a user determines the user's value category. In this example, the score ranges from 261 to 1181.

The Constant reflects the intercept of the equation reflecting the value of a user when exhibits median behavior.

Number of Internet actions indicates simply the total number of advertising company client web site interactions of the user recorded by the advertising service company and stored in the company's records.

Number of clicks at advertiser/client web site is a client specific variable. The advertising service company, in conducting an advertising campaign for the advertiser client makes special note for each user of the number of clicks (response to an advertisement) by the user for the client's advertisement.

Number of advertiser impressions is the number of impressions served to the user on behalf of the advertising company's specific client, also a client-specific variable.

Number of clicks to advertising service company indicated the number of times the user has clicked on an advertisement served by the advertising service company, even if not the particular client for whom the campaign is being implemented.

Number of Internet downloads indicates the number of times the user has engaged in downloading activity, such as of software. This indicates activity beyond simple web surfing and viewing web pages.

Most common day of week for Internet usage, indicates the day the user has had the most activity recorded. In this example, relating to a client providing a purchase research tool for automobiles, a user with heaviest Monday activity proves to have high propensity to advance to more activity, possibly because many people visit car dealers on the weekend, then conduct price comparison research Monday.

Web surfing genre category indicates the type of information and sites preferred by the user when browsing.

Number of homepage actions indicates number of times a cookie has gone to any of the advertising company's client's homepage.

Number of promotional actions indicates number of times a cookie has surfed any of the advertising company's client's promotional ad across the internet.

Most common time of Internet usage indicates when the user is most likely to have been recorded as using the Internet. As indicated in this example, late night users prove to be less likely to advance in activity level than others.

A multitude of other variables may be hypothesized, many of which may be proven useful indicators for different clients, and different campaigns. Such alternative variables include:

First Time Seen (MMYY)

Lifetime number of actions

Lifetime number of Buy actions

Lifetime number of registration actions

Lifetime number of Homepage actions

Lifetime number of promotional actions

Lifetime Number of Shopping Actions

Lifetime Number of Download Actions

Lifetime number of impressions

Lifetime number of clicks

IP Address (Most Recent)

Monthly number of actions

Monthly number of Buy actions

Monthly number of registration actions

Monthly number of Homepage actions

Monthly number of promotional actions

Monthly number of Shopping Actions

Monthly Number of Download Actions

Monthly number of impressions

Monthly number of clicks

Night owl, Daytime, Evening, and Morning use indicator (impressions)

Number of Night owl Impressions

Number of Daytime Impressions

Number of Evening Impressions

Number of Morning Impressions

Day of Week use indicator (impressions)

Number of Sunday Impressions

Number of Monday Impressions

Number of Tuesday Impressions

Number of Wednesday Impressions

Number of Thursday Impressions

Number of Friday Impressions

Number of Saturday Impressions

Genre Category (impressions)

Most Common Industry Interest Aggregation (actions)

Client First Time Seen (MMYY)

Client Lifetime number of actions

Client Lifetime number of Buy actions

Client Lifetime number of registration actions

Client Lifetime number of Homepage actions

Client Lifetime number of promotional actions

Client Lifetime Number of Shopping Actions

Client Lifetime Number of Download Actions

Client Lifetime number of impressions

Client Lifetime number of clicks

Number of Client Lifetime Primary Actions

Number of Client Lifetime Secondary Actions

Number of Client Lifetime Tertiary Actions

Number of Client Lifetime “N” priority Actions

Monthly Client number of actions

Monthly Client number of Buy actions

Monthly Client number of registration actions

Monthly Client number of Homepage actions

Monthly Client number of promotional actions

Monthly Client Number of Shopping Actions

Monthly Client Number of Download Actions

Monthly Client number of impressions

Monthly Client number of clicks

Number of Client Monthly Primary Actions

Number of Client Monthly Primary Actions

Number of Client Monthly Secondary Actions

Number of Client Monthly Tertiary Actions

Number of Client Monthly “N” priority Actions

The matrix generated by this technique is used by the advertising service company each time a user is to be served an advertisement. First, the user is identified, and the company's database is searched for a record associated with that user. Based on the particulars of the current visit by the user, and on all the past recorded activity, the activity level and value level are calculated. Each of these is assigned to the corresponding category on the matrix, and an activity in the associated cell in initiated, typically by selecting a particular banner ad to serve, or by using selected other Internet advertising techniques (channel, content).

While the above is discussed in terms of preferred and alternative embodiments, the invention is not intended to be so limited. For instance, not all data used to generate the matrix need be derived from web activity, some non-web activity may also be employed in addition to the web data. Similarly, not all the advertising techniques used to fill the cells of the matrix need be web or other electronic communications; other conventional techniques may be employed in some cells of the matrix.

1. A method of commercial Internet-based communication comprising:
generating a reference data set based on a set of responses by a set of reference users to a selected set of a plurality of different Internet communications;
establishing a plurality of user activity categories, each corresponding to a different level of user activity;
analyzing the data set to establish a plurality of value indicators based on a propensity of the reference user to move to an activity category having a higher level of activity; and
for each of at least some of the permutations of activity category and value indicator, establishing an Internet communication from the selected set.

2. The method of claim 1 including receiving an Internet communication from a user, determining the activity category of the user, calculating a value indicator for the user, and transmitting a communication to the user based on the activity category and the value indicator.

3. The method of claim 2 wherein transmitting a communication includes displaying an advertisement on a web page.

4. The method of claim 2 wherein transmitting a communication includes sending a promotional email.

5. The method of claim 2 wherein determining the value indicator includes searching a database of prior activities of the user.

6. The method of claim 2 wherein determining the value indicator includes determining a unique identifier associated with the user, and looking up other activities associated with the unique identifier.

7. The method of claim 2 wherein the value indicator is generated as a function of a plurality of characteristics of the reference data set.

8. The method of claim 7 wherein at least one of the characteristics is selected from a group comprising: number of Internet actions, number of interactions with a particular entity, number of clicks at a particular site, number of advertisements served, number of advertisements for a particular entity served, number of Internet downloads, day of the week of Internet usage, web surfing category preferences, number of actions at a particular web page, number of promotional actions received, and time of day of Internet usage.

9. The method of claim 8 wherein each of a selected plurality of the characteristics is assigned a value weighting, and a total score based on the value weightings determines the value indicator.

10. The method of claim 1 including generating a visual representation of the permutations of activity category and value indicator, including graphically mapping different selected Internet communications to locations associated with locations of the activity category and value indicator

11. The method of claim 8 wherein the visual representation is a matrix, and wherein the activity category is represented along a first axis of the matrix, the value indicator is represented along a second axis of the matrix, and the different selected Internet communications are assigned to cells of the matrix.

12. The method of claim 1 performing a multivariate analysis of the data set.

13. The method of claim 1 wherein the Internet communications include advertising messages.

14. A method of selecting commercial Internet communications comprising:
based on prior Internet activities of a plurality of past users, generating a value function predictive of propensity to engage in further action;
determining a user's history of action at a particular Internet entity;
determining other past activities of the user;
applying the value function to the past activities to generate an action advancement propensity value;
selecting a communication to the user based on the user's history of action and the action advancement propensity value.

15. The method of claim 14 wherein generating a value function includes generating a reference data set based on a set of responses by a set of reference users to a selected set of a plurality of different Internet communications.

16. The method of claim 14 including transmitting the communication by displaying an advertisement on a web page.

17. The method of claim 14 including transmitting the communication by sending a promotional email.

18. The method of claim 14 wherein determining a user's history of action and other past activities includes determining a unique identifier associated with the user, and looking up other activities associated with the unique identifier.

19. The method of claim 14 wherein the value function is in the form of a matrix, and wherein selecting a communication comprises identifying a communication associated with a matrix cell associated with the user's past activities, and with the user's action advancement propensity value

20. The method of claim 14 wherein the past activities include at least one item selected from a group comprising: number of Internet actions, number of interactions with a particular entity, number of clicks at a particular site, number of advertisements served, number of advertisements for a particular entity served, number of Internet downloads, day of the week of Internet usage, web surfing category preferences, number of actions at a particular web page, number of promotional actions received, and time of day of Internet usage.
